(19) United States
(12) Patent Application Publication
(10) Pub. No.: US 2015/0046187 A1
(43) Pub. Date: Feb. 12, 2015

(54) CLINICAL TRIAL PARTICIPANT TRANSPORTATION SYSTEM

(71) Applicant: TCN Technologies, LLC, Needham, MA (US)

(72) Inventors: Michael S. Johnson, Weymouth, MA (US); Joan F. Bachenheimer, Hull, MA (US); Jennifer C. Dinkel, Brighton, MA (US); Matthew L. Kibby, Sharon, MA (US)

(21) Appl. No.: 14/454,472

(22) Filed: Aug. 7, 2014

Related U.S. Application Data
(60) Provisional application No. 61/863,733, filed on Aug. 8, 2013.

(51) Int. Cl. G06Q 50/30; G06Q 20/40; G06F 19/00

(52) U.S. Cl. CPC G06Q 50/30; G06F 19/363; G06Q 20/40
USPC 705/3

(57) ABSTRACT

A system and method for connecting a clinical trial participant with a transportation provider. The system, based on information from an authentication mechanism, determines whether an individual requesting desired transportation is an authenticated clinical trial participant having a participant record in a patient recruitment management system database. The system, based on information from an authorization mechanism, determines whether the authenticated clinical trial participant is an authorized clinical trial participant for procurement of the transportation being requested. When the authenticated clinical trial participant is the authorized clinical trial participant for the desired transportation, the patient recruitment management system outputs an indication of approval to connect the clinical trial participant with a transportation provider. When the authenticated clinical trial participant is not the authorized clinical trial participant for the desired transportation, the patient recruitment management system outputs an indication of disapproval to connect the individual requesting desired transportation with a transportation provider.

### RELATED APPLICATION(S)

This application claims priority to, and the benefit of, co-pending U.S. Provisional Application No. 61/863,733, filed Aug. 8, 2013, for all subject matter common to both applications. The disclosure of said provisional application is hereby incorporated by reference in its entirety.

### FIELD OF THE INVENTION

The present invention relates to a clinical trial participant transportation system, and more particularly to a system and method for procuring transportation for clinical trial participants to be conveyed to a clinical trial location, thereby minimizing the obstacles to meet required participation visit schedules and maintaining the integrity of data collection requirements.

### BACKGROUND OF THE INVENTION

In carrying out clinical research for pharmaceuticals, medical devices, and biologics, there are many electronic data collection and operational support systems, including clinical trial management systems, patient recruitment management systems, or electronic data capture systems. Generally, in the patient recruitment process a company with a product, such as, but not limited to, a pharmaceutical company with a new drug, or a medical device company with a new medical device, has studies (e.g., trials) that require completion to a degree of regulatory satisfaction. The company contracts with investigational sites for the completion of the studies, while the investigational sites are responsible for recruiting patients, having the studies completed, and reporting results of the studies. Part of the conventional clinical trial process includes study participants traveling to the research site or other healthcare locations to be monitored by physicians, to have diagnostic or other like testing performed, to replenish test materials and medications, or to report any symptoms or side effects of concern to the patient or the physician.

Patients may travel to these visits by any of a number of means, but for many participants who are encumbered with mobility or cognitive impairments, obtaining transportation to the visits may be more difficult. Also, patients who rely on others for their travel, or parents who must transport one or more children with them to a study visit, often miss study visits due to challenges in coordinating transportation.

There are several methods currently utilized to assist study participants with travel. One approach involves reimbursing patients for the cost of their travel including mileage, parking, taxi cabs, bus or subway fares and the like. Some research sites provide van services to take patients from one location within a hospital campus to another such as a physician office to an imaging center, once the patient has gotten themselves to the hospital. Some research sites in urban areas provide vouchers for taxi cab services. Also, there are public transportation programs, such as the “Ride” through the Massachusetts Bay Transportation Authority (MBTA), for people with disabilities. These programs/services can offer door to door transportation for medical appointments.

### SUMMARY

There is a need for a clinical trial participant transportation system that integrates with a clinical trial management system to provide integration with study-specific regulatory requirements and sponsor-required reporting functionality, for example. The present invention system removes transportation obstacles for clinical trial participants needing to get to and from their study visits—at doctors' offices, hospitals, labs, etc.—in a manner that is more supportive than merely reimbursing the individuals for their travel costs. There is a need for a system that can authenticate the eligibility of an individual for transportation, authorize the transportation such as controlling the authorized locations for pick up and drop off, provide support for physically and/or emotionally impaired individuals, and centralize the documentation of transportation and costs by participants. The present invention addressees these needs in addition to other aspects described herein.

In accordance with an embodiment of the present invention, a system for connecting an individual requesting desired transportation with a transportation provider has a patient recruitment management system. The patient recruitment management system has a patient recruitment management system database storing a plurality of participant records. Each participant record is stored in association with each patient of a plurality of patients participating in a clinical trial. Each participant record contains data concerning a participant and a clinical trial in which the participant is enrolled. The authentication mechanism is configured to receive information from a transportation request portal regarding the individual requesting desired transportation and determine, using an authentication process, whether the individual is an authenticated clinical trial participant. The authorization mechanism is configured to receive information from the transportation request portal concerning the authenticated clinical trial participant and determine, using an authorization process, whether the authenticated clinical trial participant is an authorized clinical trial participant for procurement of the desired transportation requested.

In accordance with aspects of the present invention, the authentication mechanism is configured to determine whether an individual requesting desired transportation is an authenticated clinical trial participant having a participant record in a patient recruitment management system database. The patient recruitment management system is configured to output an indication that the authenticated clinical trial participant is the authorized clinical trial participant for the desired transportation, or output an indication that the authenticated clinical trial participant is not the authorized clinical trial participant for the desired transportation.

In accordance with aspects of the present invention, the patient recruitment management system is configured to connect the clinical trial participant requesting desired transportation with a transportation provider portal. The transportation provider portal is in communication with a transportation provider. The transportation provider portal is in communication with a transportation aggregator configured to arrange transportation.

In accordance with aspects of the present invention, the system has a transportation request portal configured to receive the indication of approval from the patient recruitment management system. The transportation request portal is configured to connect the authorized clinical trial participant with a transportation provider portal.

In accordance with aspects of the present invention, the system has a travel aggregator system configured to receive the indication of approval. The travel aggregator system is configured to select a preferred transportation provider of a plurality of transportation providers. The preferred transportation provider can include a transportation provider system configured to procure transportation for the clinical trial participant.

In accordance with aspects of the present invention, the system is configured to charge a clinical trial sponsor for a cost of the desired transportation requested or provided. The system is configured to prevent authorization of a reimbursement to the authorized clinical trial participant subsequent to confirmation of transportation being scheduled. In one example, if a request is cancelled after the participant is able to provide their own transportation to a location, then the participant may be eligible for an alternative reimbursement model. The system is configured to prevent authorization of a reimbursement to the authorized clinical trial participant subsequent to confirmation of transportation occurring. The system is configured to prevent authorization of a reimbursement to the authorized clinical trial participant subsequent to confirmation of transportation being scheduled, or transportation occurring, while still allowing authorization of a reimbursement to the authorized clinical trial participant for other expenses that are not a direct cost of the transportation. In another aspect, the system has a payment card reimbursement system in operation with the patient recruitment management system for coordinating and implementing reimbursement of expenses to participants. The payment card reimbursement system is configured to not authorize reimbursement to the authorized clinical trial participant for the desired transportation.

In accordance with aspects of the present invention, the patient recruitment management system is configured to update the plurality of participant records in real-time.

In accordance with an embodiment of the present invention, a method of connecting an individual requesting desired transportation with a transportation provider includes a patient recruitment management system, based on information from an authentication mechanism, determining whether the individual requesting desired transportation is an authenticated clinical trial participant having a participant record in a patient recruitment management system database. When the individual is determined to be the authenticated clinical trial participant, the patient recruitment management system, based on information from an authentication mechanism, determines whether the authenticated clinical trial participant is an authorized clinical trial participant for procurement of the transportation being requested. The patient recruitment management system either outputs an indication that the authenticated clinical trial participant is the authorized clinical trial participant for the desired transportation, or the patient recruitment management system outputs an indication that the authenticated clinical trial participant is not the authorized clinical trial participant for the desired transportation. When the authenticated clinical trial participant is the authorized clinical trial participant for the desired transportation, the patient recruitment management system outputs an indication of approval for connecting the individual requesting desired transportation with a transportation provider to procure the desired transportation. When the authenticated clinical trial participant is not the authorized clinical trial participant for the desired transportation, the patient recruitment management system outputs an indication of disapproval of connecting the individual requesting desired transportation with a transportation provider.

In accordance with one aspect of the present invention, the patient recruitment management system connects the authorized clinical trial participant with the transportation provider. The transportation provider procures transportation for the authorized clinical trial participant. The patient recruitment management system can update a status of the participant record for the authorized clinical trial participant based on the transportation provider procuring transportation for the authorized clinical trial participant.

In accordance with one aspect of the present invention, a transportation request portal receives the indication of approval from the patient recruitment management system. The transportation request portal connects the authorized clinical trial participant with the transportation provider. The transportation provider procures transportation for the authorized clinical trial participant. The transportation request portal can be, e.g., a call center, an online interface, or other portal.

In accordance with one aspect of the present invention, a travel aggregator system receives the indication of approval from the patient recruitment management system. The travel aggregator system selects a preferred transportation provider of a plurality of transportation providers. The travel aggregator system connects the authorized clinical trial participant with the preferred transportation provider. The preferred transportation provider procures transportation for the authorized clinical trial participant.

### BRIEF DESCRIPTION OF THE FIGURES

These and other characteristics of the present invention will be more fully understood by reference to the following detailed description in conjunction with the attached drawings, in which:

FIG. 1 is a diagrammatic illustration of a clinical trial participant transportation system, according to an embodiment of the present invention;

FIG. 2 is a diagrammatic illustration of the clinical trial participant transportation system in FIG. 1 with a travel aggregator system, according to an embodiment of the present invention;

FIG. 3 is a diagrammatic illustration of the clinical trial participant transportation system in FIG. 1 with a card management system, according to one aspect of the present invention;

FIG. 4 is a flowchart illustrating an example method of implementation of the clinical trial participant transportation system, according to an embodiment of the present invention; and

FIG. 5A is a flowchart illustrating an example method of implementation of the clinical trial participant transportation system, according to one aspect of the present invention;

FIG. 5B is a continued flowchart from FIG. 5A illustrating an example method of implementation of the clinical trial participant transportation system, according to one aspect of the present invention; and

FIG. 6 is a schematic view of a computing device or system, suitable for implementing the systems and methods of the present invention.

### DETAILED DESCRIPTION

The present invention is a solution to the problem of clinical trial or study participants, for some clinical studies, missing their scheduled study visits to such an extent, in some cases, that it can threaten the integrity and usability of the study data on that patient. For example, within each clinical trial protocol, there is often a schedule of study visits and tests or activities to be completed at each visit. To remove variability in research analysis, these visits/activities must occur within an acceptable “study visit window” which typically is a date +/−48 to 72 hours. So, if a patient is supposed to come to a visit on the 15^{th} of every month, but misses two out of six visits because, e.g., they forget, they don't have a ride, their son/daughter gets sick, they don't have money for a cab, the bus/subway was late, and the like, then that patient's information may no longer be viable and a new patient may need to be enrolled in the study to replace that individual. These transportation obstacles tend to be a concern for patients with physical impairments, those with cognitive (anxieties, paranoia, schizophrenia, Alzheimer's) impairments, and pediatric participants who have to rely on others to transport them. Some of the advantages of this system include patients being able to coordinate their own travel without having to provide immediate compensation (i.e., there is no need for guaranteed, timely, reimbursement to a patient using a transportation service). Sites can coordinate travel on behalf of patients by giving sites control over improving the probability of a patient attending a scheduled visit on the right date, time, and location.

The system provides for transportation to and from each study visit. It is a convenient way to schedule and manage transportation for clinical research study participants. Participants who choose to participate in this system can arrange transportation with, e.g., a local car service that transports them to their study visits, by requesting transportation using the system of the present invention, which then coordinates the transportation. Participants are not required to make any payments.

In general, the present invention system provides study participants with easy access and implementation of transportation to and from study visits at any approved location. Drivers can readily accompany participants into and out of clinic buildings if necessary, and assist them with wheelchairs and other medical equipment if needed. Participants can enjoy more convenience while sites benefit from improved study retention and compliance.

The system of the present invention can make use of a global transportation service chosen specifically for transporting study participants to and from clinical trial visits. In many cases, patients schedule their own rides. Secure, integrated data ensures the clinical trial participant transportation system is used only as designed, and helps maintain participant privacy and safety. It is envisioned that in certain implementations of the present invention, the transportation service and tools relating to scheduling the transportation service that are not operated by the patient recruitment management system, are under the direction of the patient recruitment management system (or under the direction of the entity in control of the patient recruitment management system) commensurate with any such requirement for degree of control of all steps of any single claim under the law for patent infringement. Some key benefits of the transportation system to study staff include: helps ensure study visit compliance and retention, simple to administer, and provides a secondary source of visit confirmation. Some key benefits to study participants include: removes common barrier to study participation, eases stress of study participation for participants and caregivers, and helps ensure on-time attendance of study visits.

An illustrative embodiment of the present invention relates to a clinical trial participant transportation system for connecting an individual requesting desired transportation with a transportation provider. The patient recruitment management system has a patient recruitment management system database. Participant records are stored in the patient recruitment management system database. Each participant record is stored in association with each patient participating in the clinical trial. Each participant record contains data concerning the participant and a clinical trial in which the participant is enrolled. The data is accessible by the patient recruitment management system, e.g., for purposes of using an authentication mechanism and an authorization mechanism. The authentication mechanism receives information from a transportation request portal regarding the individual requesting desired transportation. The authentication mechanism determines, using an authentication process, whether the individual requesting desired transportation is an authenticated clinical trial participant. The authorization mechanism receives information from the transportation request portal concerning the authenticated clinical trial participant. The authorization mechanism determines, using an authorization process, whether the authenticated clinical trial participant is an authorized clinical trial participant for procurement of the desired transportation being requested. The patient recruitment management system can output an indication that the authenticated clinical trial participant is the authorized clinical trial participant for the desired transportation, or can output an indication that the authenticated clinical trial participant is not the authorized clinical trial participant for the desired transportation. When the authenticated clinical trial participant is the authorized clinical trial participant for the desired transportation, the patient recruitment management system outputs an indication of approval to connect the clinical trial participant desiring transportation with a transportation provider. When the authenticated clinical trial participant is not the authorized clinical trial participant for the desired transportation, the patient recruitment management system outputs an indication of disapproval to connect the individual requesting desired transportation with a transportation provider. For example, the patient recruitment management system can be linked to scheduled study visits in the participant record for determining whether a clinical trial participant is an authenticated clinical trial participant and/or whether the authenticated clinical trial participant is an authorized clinical trial participant. The patient recruitment management system can authenticate/authorize based on unscheduled visits, as well as many other variables, parameters, or the like, as will be appreciated by one of skill in the art in view of the teachings contained herein.

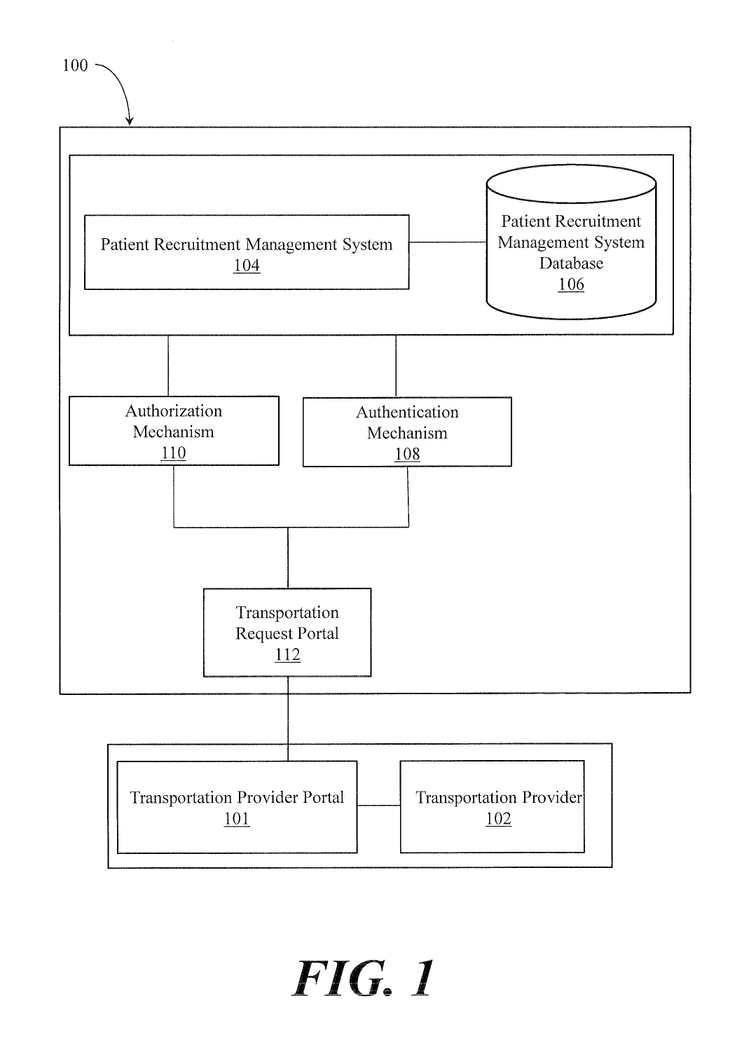

FIGS. 1 through 6, wherein like parts are designated by like reference numerals throughout, illustrate an example embodiment or embodiments of a clinical trial participant transportation system according to the present invention. Although the present invention will be described with reference to the figures, it should be understood that many alternative forms can embody the present invention. One of skill in the art will additionally appreciate different ways to alter the parameters disclosed, such as the size, shape, or type of elements or materials, in a manner still in keeping with the spirit and scope of the present invention.

Turning first to FIG. 1, a clinical trial participant transportation system 100 connects an individual requesting desired transportation with a transportation provider 102 when that individual can be authenticated and determined to be authorized for the desired transportation requested. The clinical trial participant transportation system 100 has a patient recruitment management system 104. The patient recruitment management system 104 has a patient recruitment management system database 106.

The patient recruitment management system 104 and patient recruitment management system database 106 can take many forms. Patient recruitment management systems are essentially customizable software systems used by biotech and pharmaceutical companies and researchers to manage clinical trials and all of the substantial amounts of data that corresponds with the clinical trial process. A patient recruitment management system can often manage planning, preparation, performance, and reporting of clinical trials. With respect to the patient participants, the patient recruitment management system can track actions taken, milestones, upcoming deadlines or study visits, and can often generate summary reports based on such data. Some patient recruitment management system software applications include a dashboard presentation of information to enable user interaction. The patient recruitment management system database 106 can take the form of a single database or multiple databases able to communicate therebetween, as would be appreciated by those of skill in the art.

On the tracking and report side of such systems, features that include budgeting, patient management, and government regulation compliance are often necessary. In addition, these systems should also offer good compatibility with other software systems that may feed information to the patient recruitment management system or receive information from the patient recruitment management system.

A clinical trial will in most instances have one or more entities serving a sponsor role. The sponsor is responsible for funding the clinical trial, and often sets requirements and wants reports and summaries as to project status, budget and financials, patient management and recruitment, government compliance, and the like. In some instances a research entity will play the role of the sponsor, and in other instances the sponsor will be a corporation.

Patient recruitment management systems can take many forms, including enterprise based, cloud based, or other software as a service (SaaS) modalities, or can be based in a particular server or collection of servers as would be appreciated by those of skill in the art. All such implementations of patient recruitment management system are anticipated for use with the present invention.

Participant records are stored in the patient recruitment management system database 106. Each participant record is stored in association with each patient enrolled in a particular clinical trial. Each participant record contains data concerning the participant and a clinical trial in which the participant is enrolled. The data is accessible by the patient recruitment management system 104. In implementing the present invention, the data can be accessed by the authentication mechanism 108 and the authorization mechanism 110 to determine whether an individual requesting desired transportation is both an authenticated participant of a clinical trial, and also authorized as a clinical trial participant to receive the desired transportation requested.

For example, when an individual contacts the clinical trial participant transportation system 100 with a request to have certain desired transportation from one location to another, the clinical trial participant transportation system 100 can take that request and determine whether to coordinate access to the desired transportation. The clinical trial participant transportation system 100 determines whether the individual requesting desired transportation is actually a participant enrolled in a clinical trial being managed by the patient recruitment management system 104. Some basic information is collected from the individual and compared with participant records in the patient recruitment management system 104 to identify whether they are a participant. If the individual is in the system as a participant, the clinical trial participant transportation system 100 then examines the details of the desired transportation, including such things as pickup location, drop-off location, time of day, date, form of transportation (e.g., car service, taxi, shuttle, van, etc.) and determine whether the specific desired transportation matches up with what would be expected and allowable under the parameters of the clinical trial. In particular, the pickup and drop-off location is a pre-designated location. These authentication and authorization processes eliminate the possibility of an unknown individual who is not a clinical trial participant obtaining access to free transportation. The processes likewise eliminate the possibility of a clinical trial participant obtaining access to free transportation that is not related to their required visits for the clinical trial (because by limiting the parameters of the transportation, the transportation is only arranged when the participant is actually scheduled to be at the clinical trial location at a predetermined time and place). If an authenticated clinical trial participant attempts to arrange desired transportation that does not match up with the particular parameters authorized, then the clinical trial participant transportation system 100 will not enable the participant to procure the desired transportation.

Turning to the particulars of the clinical trial participant transportation system 100, the authentication mechanism 108 is configured to receive information from a transportation request portal 112 (i.e., call center, online interface, or other form of portal) regarding an individual requesting desired transportation. The authentication mechanism 108 determines, using an authentication process, whether an individual requesting desired transportation is an authenticated clinical trial participant. The determination can be, e.g., based on whether the individual has a participant record in the patient recruitment management system database 106 for one or more clinical trials being managed by the patient recruitment management system 104. When the authentication mechanism 108 determines that the individual requesting desired transportation is an authenticated clinical trial participant, the authorization mechanism 110 can then proceed. When the authentication mechanism 108 determines that the individual requesting desired transportation is not authenticable as a participant in a clinical trial being managed by the patient recruitment management system 104, then the clinical trial participant transportation system 100 can halt the process at that point and output an indication that the individual requesting desired transportation is not a clinical trial participant (and therefore is unable to procure or arrange for transportation using the clinical trial participant transportation system 100).

Again, if the authentication mechanism 108 is able to authenticate the individual as a clinical trial participant, the authorization mechanism 110 determines, using an authorization process, whether the authenticated clinical trial participant is an authorized clinical trial participant for procurement of the desired transportation being requested. The authorization mechanism is configured to receive information from the transportation request portal 112 concerning the authenticated clinical trial participant. Authorization for a clinical trial participant for the specific desired transportation can include an examination of numerous different parameters referenced by the authorization mechanism. For example, the parameters considered can include, pickup location, drop-off location, time of day, date, form of transportation (e.g., car service, taxi, van, shuttle, etc.), clinical trial to invoice, and the like. The pickup and drop-off location is a pre-designated location. Those of skill in the art will appreciate that other parameters can be identified and set for consideration by the authorization process, such that the present invention is by no means limited to those parameters identified herein. The intent of the parameters is to create a filter to identify when a participant is requesting transportation that is actually required for the clinical trial, versus when a participant is requesting transportation that is not related to the clinical trial (and therefore should not be approved and charged to the clinical trial). This is a distinct difference from other conventional transportation systems, which may issue a pre-paid card, or other form of card or account information for an individual to have access to in arranging and paying for transportation. In such conventional systems, any policing or authorization of the transportation occurs after the transportation has actually been utilized (and is enforced by e.g., denying payment or denying reimbursement to the individual after the fact, which can be cumbersome, time consuming to manage, and difficult to enforce). The system of the present invention avoids such issues by determining before the desired transportation is even arranged, whether the transportation meets with the parameters for later payment by, e.g., the clinical trial or whomever has arranged for payment via the relevant management system.

The patient recruitment management system 104 can output an indication that the authenticated clinical trial participant is the authorized clinical trial participant for the desired transportation, or the patient recruitment management system 104 can output an indication that the authenticated clinical trial participant is not the authorized clinical trial participant for the desired transportation, based on the authorization process and parameters as discussed herein. For example, one aspect of authorization may include that the authenticated clinical trial participant has signed/executed a transportation participation agreement which allows for the authenticated clinical trial participant to be able to use the patient recruitment management system 104 for setting up transportation. In this example, if the authenticated clinical trial participant has not signed/executed a transportation participation agreement, the authenticated clinical trial participant is not an authorized clinical trial participant.

When the authenticated clinical trial participant is determined to be the authorized clinical trial participant for the desired transportation, the patient recruitment management system 104 can output an indication of approval. The approval can then be relied upon to initiate connection between the individual requesting desired transportation (who has been verified as an authorized clinical trial participant for that desired transportation) and a transportation request portal 112, which arranges transportation with a transportation provider 102 via a transportation provider portal 101. When the authenticated clinical trial participant is not the authorized clinical trial participant for the desired transportation, the clinical trial participant transportation system 100 is configured to output an indication of disapproval to the individual requesting desired transportation, which effectively terminates the process. Likewise, when the individual requesting desired transportation was not authenticated in the earlier step, the system 100 can output and indication of disapproval to the individual requesting desired transportation, which effectively terminates the process.

In accordance with an example embodiment of the present invention, the clinical trial participant transportation system 100 connects the authorized clinical trial participant desiring transportation with the transportation provider portal 101 and the transportation provider 102 when there is an indication of approval. The transportation provider portal 101 may be configured as a call center, an online reservation system, or some other form of communication, offered by a third party transportation provider, as would be appreciated by those of skill in the art.

As shown in FIG. 1, the clinical trial participant transportation system 100 has a transportation request portal 112 that may be in the form of a call center. One of skill in the art will appreciate that the transportation request portal 112 can take many forms, including but not limited to a call center, a chat room, an online interface, or any form of communication accessible by the individual requesting desired transportation, such that the present invention is not limited to the particular embodiments described herein. The transportation request portal 112 receives the indication of approval or disapproval from the authentication mechanism 108 and/or the authorization mechanism 110, and/or the patient recruitment management system 104, and/or the clinical trial participant transportation system 100. The indication of approval or disapproval can be forwarded or communicated to the transportation request portal 112 using a number of different configurations and pathways, as would be appreciated by those of skill in the art. The transportation request portal 112 can connect the individual requesting desired transportation with the transportation provider portal 101. The transportation provider portal 101 can be in communication with a transportation provider 102.

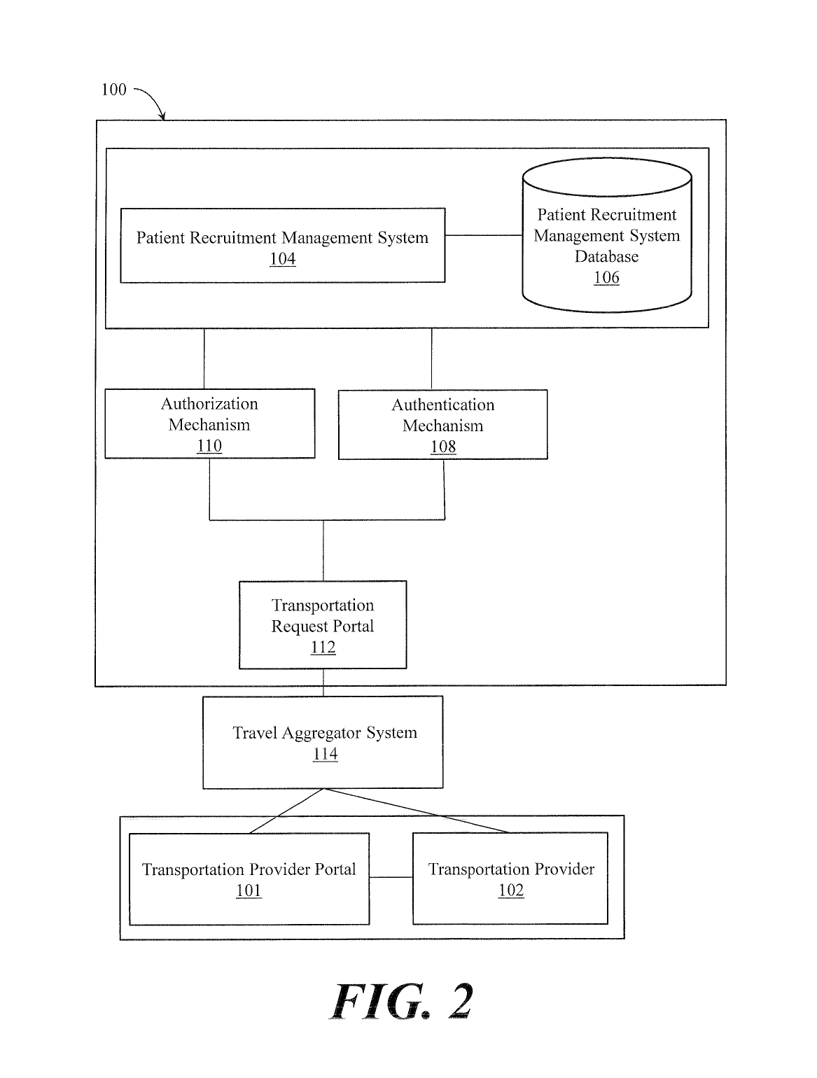

FIG. 2 depicts the clinical trial participant transportation system 100 with a travel aggregator system 114. The travel aggregator system 114 receives the indication of approval from the transportation request portal 112 based on the results of the output from the authorization mechanism 110 and the authentication mechanism 108. The travel aggregator system 114 can select a preferred transportation provider 102 out of a group of transportation providers. The travel aggregator system 114 can fully vet the drivers and vehicles used in the travel, in order to minimize the risks associated with taxi cabs (no shows, cost, trust, etc.). The preferred transportation provider 102 can include a transportation provider system that procures transportation for the authorized clinical trial participant. The travel aggregator system 114 may be in communication with the transportation provider portal 101 for arranging transportation. In particular, the travel aggregator system 114 may utilize the transportation provider portal 101 in communication with a selected preferred transportation provider 102.

A patient retention system such as the patient recruitment management system 104 may be linked with the travel aggregator system 114 (blinded to users) to incorporate the best features of a logistics management system—including calling patients when vehicle is at their location, calling drivers prior to and after the ride, etc. In most cases, patients may be picked up by the same one or two drivers for each visit adding to trust, comfort, etc. that is quite critical for people whose mobility or cognition is impaired (arthritis, post-surgical, stroke, schizophrenia, Alzheimer's disease, etc.). Drivers can assist patients out of their homes, into the vehicles, into the study site location and the reverse process. The same driver can wait for the participant for the return journey.

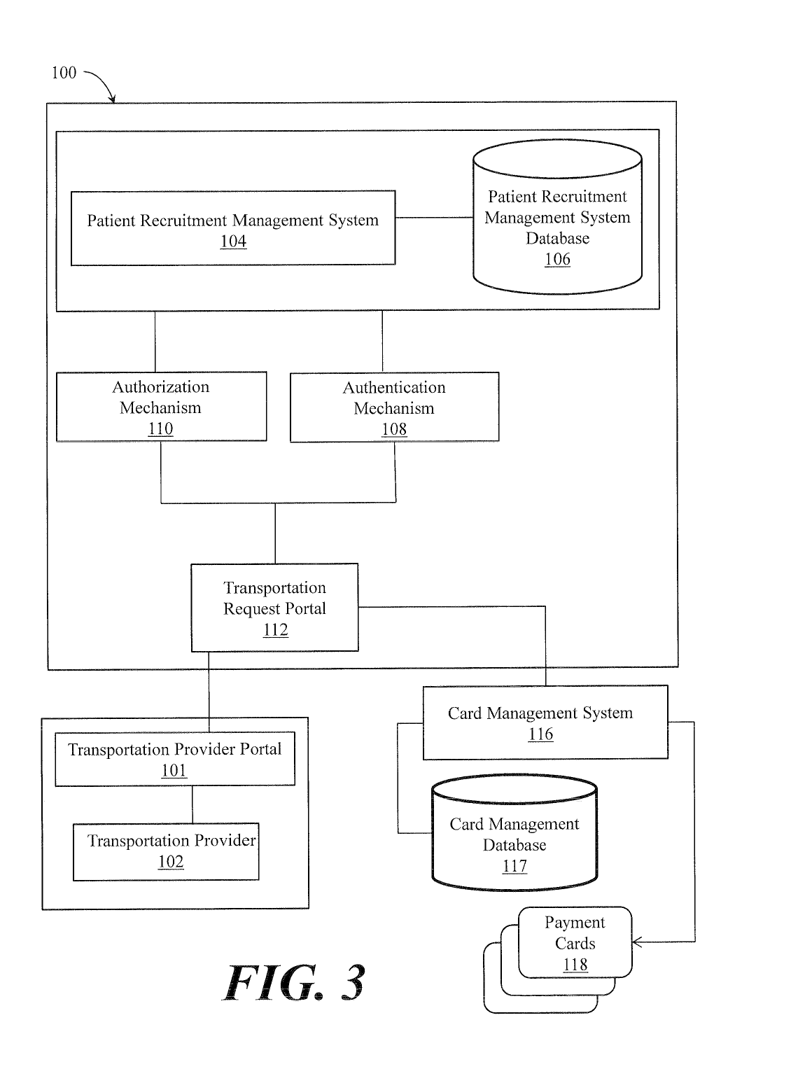

FIG. 3 depicts the clinical trial participant transportation system 100 with one form of a clinical trial reimbursement system configured as a card management system 116. The card management system 116 can have a card management system database 117. Reloadable payment cards 118 are managed by the card management system 116. Reloadable payment card unique identification strings can be stored in the card management system database 117. Each payment card unique identification string is assigned to each of the reloadable payment cards 118. Within the patient recruitment management system database 106, each of the reloadable payment card unique identification strings is associated with each of the participant records. The patient recruitment management system 104 can load the reloadable payment cards 118 upon receipt of an instruction to load the reloadable payment card 118. The instruction may contain an indication of quantity.

In another example, the clinical trial participant transportation system 100 can be configured to charge a clinical trial sponsor for a cost of the requested desired transportation. The system 100 may be configured to prevent authorization of a reimbursement to the authorized clinical trial participant subsequent to the confirmation of the desired transportation having been scheduled. The clinical trial participant transportation system 100 can be configured to prevent authorization of a reimbursement to the authorized clinical trial participant subsequent to confirmation of the desired transportation occurring. In another example, the system is configured to prevent authorization of a reimbursement to the authorized clinical trial participant subsequent to the confirmation of the desired transportation being scheduled and provided, or the desired transportation occurring, while still allowing authorization of a reimbursement to the authorized clinical trial participant for other expenses that are not a direct cost of the desired transportation. The system 100 can have a payment card reimbursement system in operation with the patient recruitment management system for coordinating and implementing reimbursement of expenses to participants. The payment card reimbursement system may be configured to not authorize reimbursement to the authorized clinical trial participant for the desired transportation.

In accordance with an example embodiment of the present invention, the patient recruitment management system 104 can be instructed to load the reloadable payment card 118 for an activity by the clinical trial participant. However, used in conjunction with the clinical trial participant transportation system 100 of the present invention, the action of reimbursement for a transportation expense resulting from the participant requesting and using the desired transportation as described herein can be more actively managed and controlled. Specifically, the clinical trial participant transportation system 100 can be configured in such a way that when a participant makes use of the clinical trial participant transportation system 100 as described herein to arrange for, and utilize, transportation, the cost for that transportation can be directly billed to the clinical trial sponsor (e.g., via the patient recruitment management system 104, or using other known mechanisms). In such an arrangement, the participant never has to pay the transportation provider 102 directly, and therefore, does not require reimbursement. The clinical trial participant transportation system 100 can record when the transportation is utilized, and obtain payment from the clinical trial sponsor. In such an instance, if the participant subsequently puts in a request for reimbursement, the clinical trial participant transportation system 100 can deny that request for reimbursement of the transportation expense. Such denial is relatively easy to manage when the reimbursement is done in person (e.g., the participant hands the clinical trial location a copy of a receipt, they check the clinical trial participant transportation system 100 and/or the patient recruitment management system 104 to determine whether that transportation has already been reimbursed, or has already been billed to the clinical trial sponsor, and a determination is made whether reimbursement can occur). However, in systems where a payment card 118 is utilized to receive the reimbursement, the present clinical trial participant transportation system 100 can manage that process as well.

More specifically, for example, the patient recruitment management system 104 is instructed by the clinical trial participant transportation system 100 not to load the reloadable payment card 118 where the activity is the transportation of a clinical trial participant with the transportation provider 102 and the costs for that particular transportation were not paid by the participant. The costs for the desired transportation service are invoiced to the card management system 116 for example by using pre-negotiated rates that vary by geographic location, visit length, travel distance, etc. This provides the study sponsor with predictable costs for the desired transportation service. Specifically, the reimbursement process, where many different items may be reimbursed to the payment card 118, can still be operational. However, the specific reimbursement expense for one instance of transportation that was arranged and otherwise paid for using the clinical trial participant transportation system 100 can be flagged or identified in the patient recruitment management system 104, such that the transportation expense/cost will not be able to be reimbursed to the payment card 118 (while other reimbursement activities to the payment card 118 can still be allowed to occur). For example, a participant can use the clinical trial participant transportation system 100 for one visit and the payment card 118 for all other visits, or the reimbursement card 118 for one visit and the transportation system 100 for all other visits. Said differently, the reimbursement can be flagged, blocked, etc., for a particular instance of transportation when it has been paid for through use of the clinical trial participant transportation system 100 and directly charged/billed to the clinical trial or study sponsor, such that the specific instance of transportation cannot be later reimbursed upon the participant submitting a receipt or other reimbursement request, or the like. However, other instances of transportation that are not arranged for and paid using the clinical trial participant transportation system 100 can be reimbursed to the participant upon request.

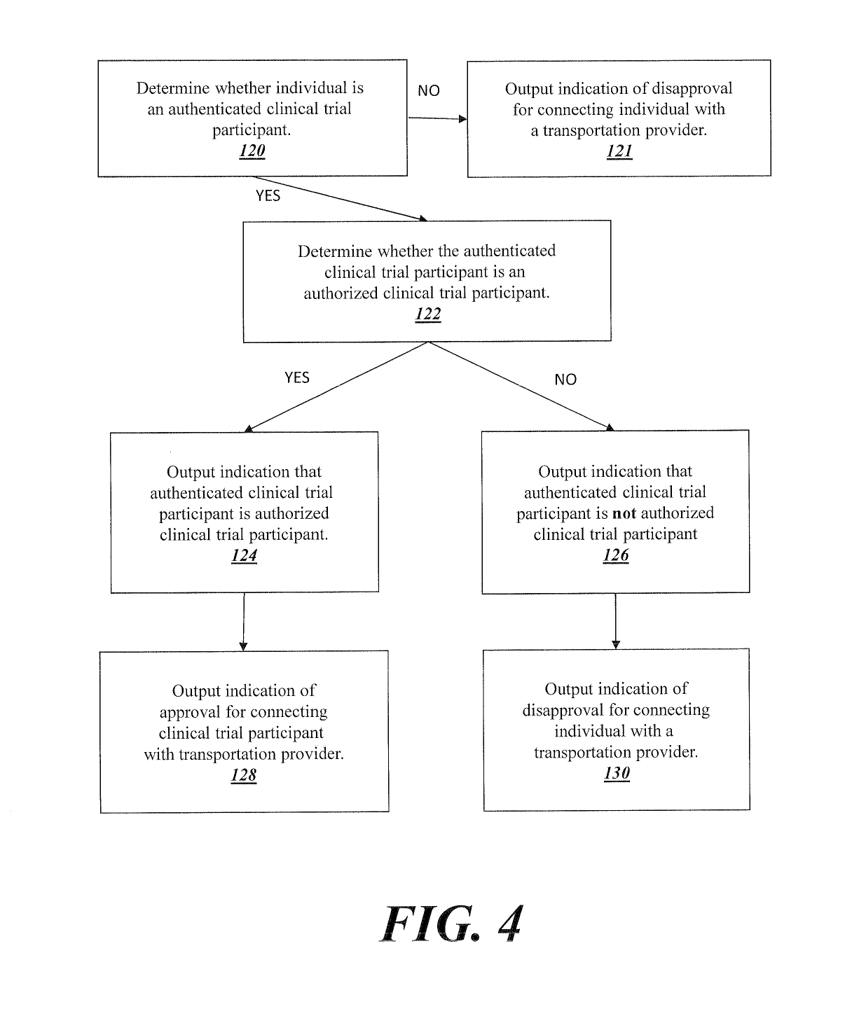

FIG. 4 illustrates a method of implementation of the clinical trial participant transportation system 100. The method is for connecting an individual requesting desired transportation with a transportation provider 102. The patient recruitment management system 104 uses the authentication mechanism 108 to determine whether the individual requesting desired transportation is an authenticated clinical trial participant (step 120). An authenticated clinical trial participant has a participant record in a patient recruitment management system database 106. When the individual is determined to be the authenticated clinical trial participant, the patient recruitment management system 104 uses an authorization mechanism 110 to determine whether the authenticated clinical trial participant is an authorized clinical trial participant for procurement of the transportation being requested (step 122). If the result of step 122 is “yes”, the patient recruitment management system 104 outputs an indication that the authenticated clinical trial participant is the authorized clinical trial participant for the desired transportation (step 124). If the result of step 122 is “no”, the patient recruitment management system 104 outputs an indication that the authenticated clinical trial participant is not the authorized clinical trial participant for the desired transportation (step 126). When the authenticated clinical trial participant is the authorized clinical trial participant for the desired transportation, the patient recruitment management system 104 outputs an indication of approval for connecting the individual requesting desired transportation (who is also the authorized clinical trial participant) with a transportation provider 102 (step 128). When the authenticated clinical trial participant is not the authorized clinical trial participant for the desired transportation, the patient recruitment management system 104 outputs an indication of disapproval for connecting the individual requesting desired transportation with a transportation provider (step 130). Again, when the individual requesting desired transportation is not authenticated as a clinical trial participant in the earlier step, then the system outputs an indication of disapproval for connecting the individual requesting desired transportation with a transportation provider (step 121).

In one example, the patient recruitment management system 104 can connect the authorized clinical trial participant desiring transportation with a transportation provider 102. The transportation provider 102 procures transportation for the clinical trial participant. In one example, the patient recruitment management system 104 can update a status of the participant record for the clinical trial participant based on the transportation provider 102 procuring transportation for the clinical trial participant.

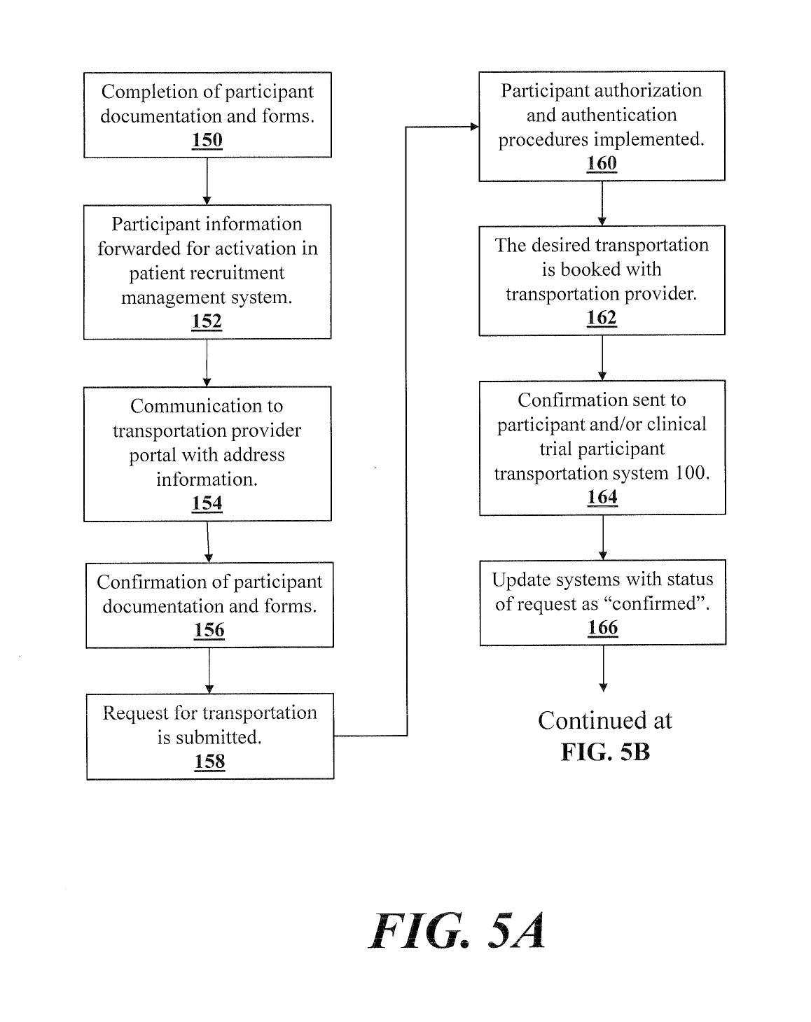

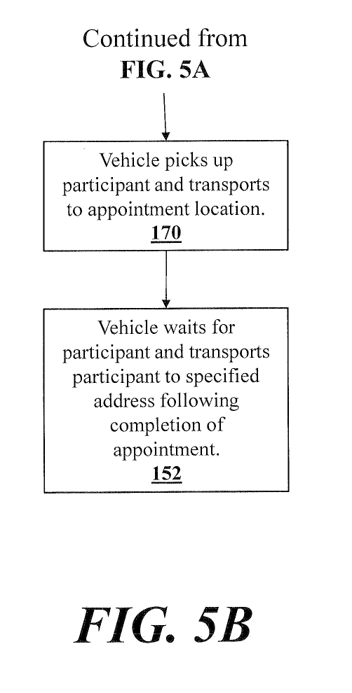

FIG. 5A depicts a specific example method of implementation of the clinical trial participant transportation system 100. In particular, this example displays the start-up and booking of a ride using the clinical trial participant transportation process. In general, participants complete and sign a participation form to opt into the transportation program, typically including two potential pick-up addresses (e.g., work and home), and/or the system confirms that such information has been received. Participants (or sites) can call a transportation request portal 112 to schedule transportation, i.e., a request for transportation is submitted. A professional transportation service can transport participants between their pre-designated location and the study clinic. All this activity is automatically tracked in real-time in a secure system as described above. For example, when the participant is picked up at their pre-designated location, a driver may cause the clinical trial participant transportation system 100 to be notified that the participant has boarded the vehicle and is now en-route to destination. Then, when the participant is dropped off at the drop-off location, the driver or personnel at the location (e.g., study clinic or doctor's office) can cause the clinical trial participant transportation system 100 to be notified that the participant has arrived at the destination. All of these actions may occur in real time.

In the FIG. 5A example, the start-up process includes sites receiving approval of the patient materials related to the clinical trial participant transportation system 100. Patients can elect to participate, but do not need to use a transportation provider or service for any visit. So, if an Alzheimer's patient's daughter cannot drive her mother to a visit, she can still get to the visit with a transportation provider or service that they know.

In accordance with an example implementation, participation forms and customer service cards are shipped to the approved sites. A patient signs a participation form and enters two addresses (step 150). The site forwards the participation form to the call center 112 for processing and activation in the patient recruitment management system 104 (step 152). An auto email or other communication is sent to a transportation provider portal 101 in communication with a transportation provider 102 with the patient address information to add to their internal system or to the transportation provider system (step 156). An individual requesting desired transportation (or a representative thereof) contacts the transportation portal to schedule transportation (step 158). If the individual is a clinical trial participant who is participating in the card management system 116 as well, the patient recruitment management system 104 and/or the card management system 116 can be updated with a confirmation that serves to block or prevent reimbursement of the transportation cost/expense once the transportation has been scheduled and implemented.

In accordance with one example embodiment of the present invention, during the booking process a patient/site can ask questions regarding the transportation program (clinical trial participant transportation system 100). The transportation request portal 112 can answer questions regarding the transportation program or notify patient to contact study site for study-specific questions. Anyone can ask to book a ride or transportation. Once the individual is authenticated and authorization is confirmed for the desired transportation (step 160), the transportation request portal 112 can transfer the caller (if the portal is a call center) to the transportation provider portal 101 of the transportation provider 102 such as the vendor's customer service line. The individual (or their agent) books the transportation with the transportation provider system (step 162). A confirmation email, or other form of confirmation, may be sent to the participant and/or the clinical trial participant transportation system 100 (step 164). The transportation request portal 112 updates the status in the patient recruitment management system 104 to “confirmed” and updates the patient recruitment management system 104 and/or the clinical trial participant transportation system 100 with transportation details (step 166).

FIG. 5B is a continued flowchart from FIG. 5A depicting the implementation of the transportation steps of an example method of the clinical trial participant transportation system. A vehicle such as a car arrives at the specified pick up address (as listed by the patient) and the vehicle brings the patient to the appointment at the clinical trial location (i.e., doctor's office) (step 170). The driver may tell the patient the location where they plan to be after the appointment is completed. The vehicle waits until the appointment is completed and then drives the patient back to the specified address (step 172). The specified address is an address that was previously submitted and approved during the participant intake process where documentation and forms were submitted, including at least two addressees (e.g., home and work).

In one example, the clinical trial participant transportation system 100 is supported by a telephone help center or call center, such as the transportation provider portal 101, that facilitates communication between the patient or site and the travel aggregator system 114. When an individual requesting desired transportation calls, they are triaged to one of two directions—auto transferred to the travel aggregator's customer service (travel aggregator system 114) to schedule transportation. Another example may be creating an electronic interface as part of the clinical trial participant transportation system 100 (specifically the patient recruitment management system 104) for patients to use to schedule the transportation, which could technically eliminate the call center function as shown in FIG. 1.

In one example, transportation can be managed through a worldwide chauffeured ground transportation company or other transportation service acting as the transportation service provider 102. An individual can call to schedule a ride 24 hours a day/7 days a week. When a participant in a clinical trial calls to schedule a ride, it is preferred that they provide a patient name or patient account number which may be located on the transportation contact card received after signing up to participate in the transportation program. The participant can indicate whether they would like to be picked up at a primary or secondary address (this information is provided during signup/registration). Then, the participant can provide the address of the study center and the time of their appointment. Alternatively, the participant does not need to provide the address of the study center because this information is part of the participant records of each participant in the patient recruitment management system database 106 of the patient recruitment management system 104. Participants may receive a confirmation email shortly after scheduling transportation. The transportation service is available to participants at no cost to the participant, since the driver is already being compensated via the clinical trial participant transportation system 100 as described herein. Transportation can be booked any time prior to a scheduled visit. For example, the ride can be booked up to 24 hours in advance or less. A participant can request to have the same driver through the system, in some instances, when available. Also, the participant can provide special instructions regarding pick up address when scheduling the transportation. If the appointment is changed or if a participant has to cancel/reschedule, the clinical trial participant transportation system 100 can be updated and the transportation rescheduled. The clinical trial participant transportation system 100 as described herein may be contacted if car has not arrived by scheduled pick-up time. When user registers for transportation service, the participant provides a primary and secondary address. These are the only two addresses where the participant can be picked up from and dropped off using the clinical trial participant transportation system 100 as described herein. If the primary address and secondary address change, the participant may need to resubmit the participation form at next visit with updated addresses. While on the way to or from an appointment, the driver can be authorized to make select additional stops. In particular, the driver is authorized to stop at a pharmacy to pick up a prescription or a local market if the participant needs to pick up supplies that are related to participation in the clinical trial. The transportation service is offered to a participant as part of their participation in the clinical research study. A participant can only use the service for transportation to and from study visits. Upon arrival at the study center, the driver may let participant know where they will be located once appointment is finished. A caregiver/friend may accompany user in transportation but they must be picked up and dropped off at the same location where user was picked up/dropped off. With control of the approved addresses and authorization required for the driver to make additional stops during the travel to or from study visits, the system prevents the participant from using the transportation service for non-clinical trial (or other non-sanctioned) transportation uses.

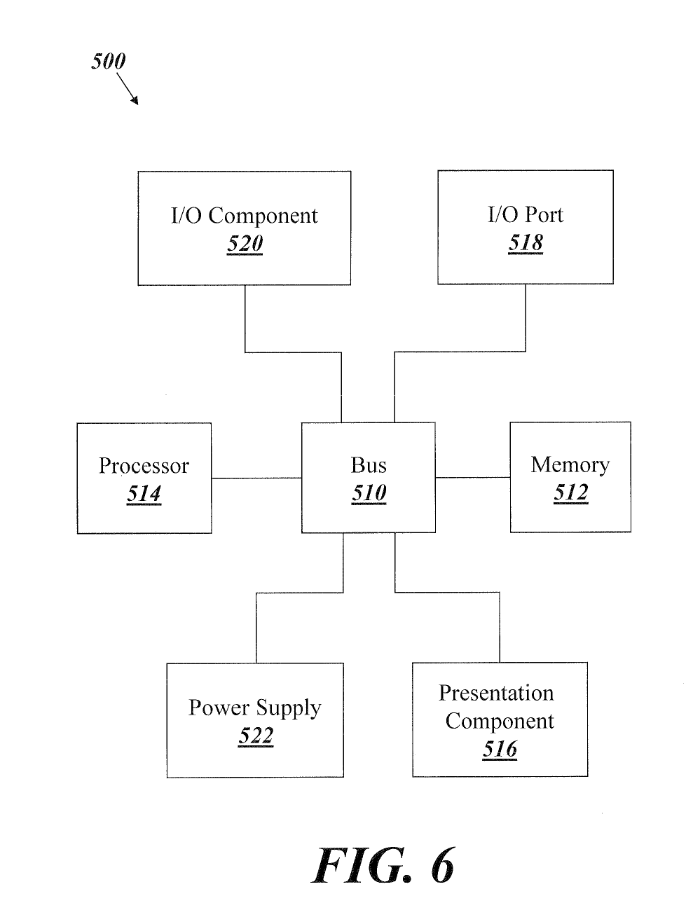

FIG. 6 illustrates an example of a computing device 500 for implementing aspects of the illustrative methods and systems of the present invention. The computing device 500 is merely an illustrative example of a suitable computing environment and in no way limits the scope of the present invention. A “computing device,” as represented by FIG. 6, can include a “workstation,” a “server,” a “laptop,” a “desktop,” a “hand-held device,” a “mobile device,” a “tablet computer,” or other computing devices, as would be understood by those of skill in the art. Given that the computing device 500 is depicted for illustrative purposes, embodiments of the present invention may utilize any number of computing devices 500 in any number of different ways to implement a single embodiment of the present invention. Accordingly, embodiments of the present invention are not limited to a single computing device 500, as would be appreciated by one with skill in the art, nor are they limited to a single type of implementation or configuration of the example computing device 500.

The computing device 500 can include a bus 510 that can be coupled to one or more of the following illustrative components, directly or indirectly: a memory 512, one or more processors 514, one or more presentation components 516, input/output ports 518, input/output components 520, and a power supply 522. One of skill in the art will appreciate that the bus 510 can include one or more busses, such as an address bus, a data bus, or any combination thereof. One of skill in the art additionally will appreciate that, depending on the intended applications and uses of a particular embodiment, multiple components can be implemented by a single device. Similarly, in some instances, a single component can be implemented by multiple devices. As such, FIG. 6 is merely illustrative of an exemplary computing device that can be used to implement one or more embodiments of the present invention, and in no way limits the invention.

The computing device 500 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 500.

The memory 512 can include computer-storage media in the form of volatile and/or nonvolatile memory. The memory 512 can be removable, non-removable, or any combination thereof. Exemplary hardware devices are devices such as hard drives, solid-state memory, optical-disc drives, and the like. The computing device 500 can include one or more processors 514 that read data from components such as the memory 512, the various I/O components 520, etc. Presentation component(s) 516 present data indications to a user or other device. Exemplary presentation components 516 include a display device, speaker, printing component, vibrating component, etc. The I/O ports 518 can allow the computing device 500 to be logically coupled to other devices, such as I/O components 520. Some of the I/O components 520 can be built into the computing device 500. Examples of such I/O components 520 include a microphone, joystick, recording device, game pad, satellite dish, scanner, printer, wireless device, blue-tooth device, networking device, and the like.

One of skill in the art will appreciate a wide variety of ways to modify and alter the system and method of FIGS. 1-6, as well as the various components with which it interacts. For example, the one or more computing systems can be implemented according to any number of suitable computing system structures. Furthermore, some or all of the information contained in the one or more data sources alternatively can be stored in one or more remote databases (e.g., cloud databases, virtual databases, and any other remote database).

In some embodiments, it may be desirable to implement the method and system using multiple iterations of the depicted modules, controllers, and/or other components, as would be appreciated by one of skill in the art. Furthermore, while some modules and components are depicted as included within the system, it should be understood that, in fact, any of the depicted modules alternatively can be excluded from the system and included in a different system. One of skill in the art will appreciate a variety of other ways to expand, reduce, or otherwise modify the system upon reading the present specification.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A system for connecting an individual requesting desired transportation with a transportation provider, the system comprising:
a patient recruitment management system having a patient recruitment management system database storing a plurality of participant records, each participant record stored in association with each patient of a plurality of patients participating in a clinical trial, wherein each participant record contains data concerning a participant and a clinical trial in which the participant is enrolled;
an authentication mechanism that receives information from a transportation request portal regarding the individual requesting desired transportation and determines, using an authentication process, whether the individual is an authenticated clinical trial participant; and
an authorization mechanism that receives information from the transportation request portal concerning the authenticated clinical trial participant, and determines, using an authorization process, whether the authenticated clinical trial participant is an authorized clinical trial participant for procurement of the desired transportation requested.

2. The system of claim 1, wherein the authentication mechanism determines whether an individual requesting desired transportation is an authenticated clinical trial participant having a participant record in the patient recruitment management system database.

3. The system of claim 1, wherein the patient recruitment management system outputs an indication that the authenticated clinical trial participant is the authorized clinical trial participant for the desired transportation, or outputs an indication that the authenticated clinical trial participant is not the authorized clinical trial participant for the desired transportation.

4. The system of claim 1, wherein the patient recruitment management system connects the authorized clinical trial participant with a transportation provider portal.

5. The system of claim 4, wherein the transportation provider portal is in communication with a transportation provider.

6. The system of claim 4, wherein the transportation provider portal is in communication with a transportation aggregator configured to arrange transportation.

7. The system of claim 1, wherein the transportation request portal receives the indication of approval from the patient recruitment management system and connects the authorized clinical trial participant with a transportation provider portal.

8. The system of claim 1, further comprising a travel aggregator system that receives the indication of approval and selects a preferred transportation provider of a plurality of transportation providers.

9. The system of claim 8, wherein the preferred transportation provider further comprises a transportation provider system that procures transportation for the authorized clinical trial participant.

10. The system of claim 1, wherein the system charges a clinical trial sponsor for a cost of the desired transportation provided.

11. The system of claim 1, wherein the system prevents authorization of a reimbursement to the authorized clinical trial participant subsequent to confirmation of the desired transportation being scheduled and provided.

12. The system of claim 1, wherein the system prevents authorization of a reimbursement to the authorized clinical trial participant subsequent to confirmation of the desired transportation occurring.

13. The system of claim 1, wherein the system prevents authorization of a reimbursement to the authorized clinical trial participant subsequent to confirmation of the desired transportation being scheduled, or the desired transportation occurring, while still allowing authorization of a reimbursement to the authorized clinical trial participant for other expenses that are not a direct cost of the desired transportation.

14. The system of claim 1, further comprising a payment card reimbursement system in operation with the patient recruitment management system for coordinating and implementing reimbursement of expenses to participants, wherein the payment card reimbursement system does not authorize reimbursement to the authorized clinical trial participant for the desired transportation.

15. The system of claim 1, wherein the patient recruitment management system updates the plurality of participant records in real-time.

16. A method of connecting an individual requesting desired transportation with a transportation provider, the method comprising:
a patient recruitment management system, based on information from an authentication mechanism, determining whether the individual requesting desired transportation is an authenticated clinical trial participant having a participant record in a patient recruitment management system database;
when the individual is determined to be the authenticated clinical trial participant, the patient recruitment management system, based on information from an authorization mechanism, determining whether the authenticated clinical trial participant is an authorized clinical trial participant for procurement of the desired transportation being requested;
the patient recruitment management system either outputting an indication that the authenticated clinical trial participant is the authorized clinical trial participant for the desired transportation, or the patient recruitment management system outputting an indication that the authenticated clinical trial participant is not the authorized clinical trial participant for the desired transportation;
when the individual requesting desired transportation is both determined to be the authenticated clinical trial participant and determined to be the authorized clinical trial participant for the desired transportation, the patient recruitment management system outputting an indication of approval for connecting the individual requesting desired transportation with a transportation provider to procure the desired transportation; and
when the individual requesting desired transportation is determined to be the authenticated clinical trial participant and is determined not to be the authorized clinical trial participant for the desired transportation, the patient recruitment management system outputting an indication of disapproval for connecting the individual requesting desired transportation with a transportation provider.

17. The method of claim 16, further comprising the patient recruitment management system connecting the authorized clinical trial participant with the transportation provider to request procurement of transportation for the authorized clinical trial participant.

18. The method of claim 17, further comprising the transportation provider procuring transportation for the authorized clinical trial participant in response to the request.

19. The method of claim 17, further comprising the patient recruitment management system updating a status of the participant record for the authorized clinical trial participant based on receipt of a confirmation of the transportation provider procuring transportation for the authorized clinical trial participant.

20. The method of claim 16, further comprising:
a transportation request portal receiving the indication of approval from the patient recruitment management system;
the transportation request portal connecting the authorized clinical trial participant with the transportation provider; and
the transportation provider procuring transportation for the authorized clinical trial participant.

21. The method of claim 20, wherein the transportation request portal is a call center.

22. The method of claim 16, further comprising:
a travel aggregator system receiving the indication of approval from the patient recruitment management system;
the travel aggregator system selecting a preferred transportation provider of a plurality of transportation providers;
the travel aggregator system connecting the authorized clinical trial participant with the preferred transportation provider; and
the preferred transportation provider procuring transportation for the authorized clinical trial participant.

23. The method of claim 16, further comprising updating, using the patient recruitment management system, a plurality of participant records in the patient recruitment management system database in real-time.

24. The method of claim 16, further comprising, when the individual is determined not to be the authenticated clinical trial participant, the patient recruitment management system outputting an indication of disapproval of connecting the individual requesting desired transportation with a transportation provider.
